(19) United States
(12) Patent Application Publication
(10) Pub. No.: US 2003/0229591 A1
(43) Pub. Date: Dec. 11, 2003

(54) International digital reference and depository for intellectual property, including a unique property identification system, and further digitally associated files applied in the promotion of commerce in digital media; and an associated method of business

(76) Inventor: Clare L. Hoke, Ontario, CA (US)

Correspondence Address: CLARE L. HOKE JR., 1318 N. MONTE VISTA AVE., SUITE 11, UPLAND, CA, 91786, US

(21) Appl. No.: 10/162,783

(22) Filed: Jun. 6, 2002

(51) Int. Cl. G06F 17/60

(52) U.S. Cl. 705/50

(57) ABSTRACT

An authoritative archive and reference for Intellectual Properties which shall serve to promote commerce and act to verify the validity of contractual agreements within digital media's. Said digital reference library housing Intellectual Property Identifiers which establish Intellectual Properties as unique and bound to restriction with regard to sale transfer and proliferation within digital media's. Said digital reference further containing information associated with individual Intellectual Properties in the interest of effecting commerce within digital media's. Said digital reference archive further serving to validate the requirements of contractual agreements employed in commerce within and without of digital domains.

### FIELD OF INVENTION

The present invention represents a method of regulating e-comerce in the interest of protecting property such as information, art, performances or ideas which are copy written, licensed, patented, industrial designs, or registered as trademarks. The present invention answers the need for a market based solution regarding the transfer, sale, and proliferation of Intellectual Properties within Digital Media. As novel methods of commerce develop and expand within the digital domain there arises a need to document not only Intellectual Properties themselves, but additional information which serves to distinguish Intellectual Property as novel within digital media. Information which distinguishes Intellectual Property as bound to restrictions with regard to sale, transfer, and proliferation, may be further associated with information intended to promote the legal sale, transfer, and proliferation of individual Intellectual and Copy written Properties. The present invention is herein presented in the interest of furthering commerce within digital mediums.

### HISTORY OF THE INVENTION

The world of electronic commerce and information distribution is developing rapidly to meet the needs of consumers, distributors and property holders while attempting at the same time to appear stable and secure. Organizations which are charged with the responsibility of defining protocols and standards for the world wide Internet Community are currently weighing the interests of Intellectual Property, Copyright and Trademark holders against the needs of nonprofit, educational and consumer sectors. Influencing such organizations as the Internet Engineering Task Force, WC3, Internet Society and ICANN, is the perception that an unregulated arena welcomes democratic principals. However, such principals are not exclusive to the public sector, and while some individuals and organizations may suffer against the perception, capitalism also excels in unregulated arenas, to the benefit of all involved parties.

The regulation of International interests has a long history of mixed results. Should the present invention be accepted willingly beyond national boundaries, as a functional market solution to International needs, a novel precedent may be established. The present invention provides a solution for the owners of property which may be traded in the world wide electronic marketplace. The concern of property owners involves receiving payment for the transfer of said property, when unaccounted for copies of properties are being distributed from individual to individual. As the velocity of computing power increases into the future, the ability to detect and record transactions of property across the electronic medias will be more readily enabled.

Much consideration is currently being given to the issue of Trademarks within the Internet Community. “Governing” Internet organizations have recently begun to establish policies and processes for remedies regarding cybersquatters and piracy of Trademarks. Additional Top Level Domains (ie. .com, .org, .net) are currently in preparation, and the effect of adding to, and subdividing the market of generic Top Level Domains (ie. .athletes, .sports) is being considered in part as a remedy for Trademark conflicts. Issues regarding the remainder of Intellectual Property within digital medias; Patents, Industrial Designs, and Copyright need to be further addressed however, in the interest of promoting commerce.

### SUMMARY OF THE INVENTION

The present invention represents a solution with regards to accountability within digital medias. In its preferred embodiment the present invention delineates methods for improving commerce within the Internet and will prove to have implications in other digital media as well. The business model included herein is intended to be illustrative, as the present invention will serve to enable expansive variations of commerce models and techniques.

In pending patent application Ser. No. 09/569,388 the author of the present invention suggests a first step in facilitating voluntary compliance with the laws of commerce within digital media requires the standardization of an Intellectual Property Identifier, which shall serve to distinguish Intellectual Property as novel within digital medias. Pending patent application Ser. No. 09/569,388 illustrates several business models describing the use of additional information associated with, and or attached and or bundled with an Intellectual Property such as a Copyright, and how such information may be employed to promote commerce in digital media. The preferred embodiment of the invention described in pending application Ser. No. 09/569,388 enables Intellectual Property to be transferred from multiple sources, retail, wholesale, and retail defacto distributors which include customers who are enabled by the invention to become distributors, based upon information associated with a particular Intellectual Property; while maintaining accountability to the property holder. However, the establishment of Intellectual Property Identifier's and the association of further information in the interest of commerce, is only the first step in establishing accountability within digital domains. For commerce to flourish, further methods of doing business are herein being delineated.

It is herein suggested that interested parties, upon successfully being granted patent, or copyright status and protection, may seek to employ an Intellectual Property Identifier in association with their Intellectual Property for applications in digital media. An Intellectual Property Identifier may further be associated with information such as a Transaction Code Identifier or designator, again distinguishing the file as an Intellectual Property, and therefore unique and bound to restrictions with regard to transfer, ownership, and proliferation. Further information to be digitally associated with an individual Intellectual Property may include: URL code(s), the name of the property holder, the name of the distributor, Trademark Information, the name of the property (song title), the name of the Publisher, descriptive text strings, requirements for purchase or transfer of ownership (or further resources if such transfer may not be accomplished directly over the Internet), product incentive information for further consumer/distributor dissemination, e-mail addresses, further computer information such as a program (applet or Java for example), return form and route for documentation of sale, the name of the Internet Servers and Web Providers involved in the transfer of the file, phone numbers, HTML document(s), the front end of a program such as Gopher, Internet domain name('s), the addresses of Web Servers, file type designations (audio), time/date code, FTP information, product update information, further artist information, artist tour dates and promotional material, pass words, music or property samples, warranty and service information, disclaimers, and accommodations for consumer feedback, in the interest of promoting commerce.

Clearly there currently exists a void with regard to registering Intellectual Property Identifiers and or associated information in a secure and referential manner. Given methods of business wherein multiple copies of Intellectual Property are in effect promoting their own multiplication, distribution, and disbursement, a referential data base of comparative and iconological information associated with Intellectual Property would need to be established.

### SUMMARY OF THE INVENTION

Accordingly, several objects and advantages of the present invention include:

(a) improved accountability of consumers to owners of Intellectual Properties.

(b) improved monitoring of transactions which involve Intellectual Properties.

(c) a novel distribution structure which promotes commerce.

(d) increased dissemination of the requirements of lawful transference of Intellectual Properties to consumers

(e) facilitation of multiple, or tiered distribution schedules of Intellectual Properties.

(h) a method for increasing consumer involvement in the proliferation of legally transferable Intellectual Properties.

(i) a method for expanding the market for individually distributed Intellectual Properties.

### BRIEF DESCRIPTION OF DRAWINGS

FIG. 1 is a chart exemplifying multiple parties referencing the contractual requirements of International commerce via the internet.

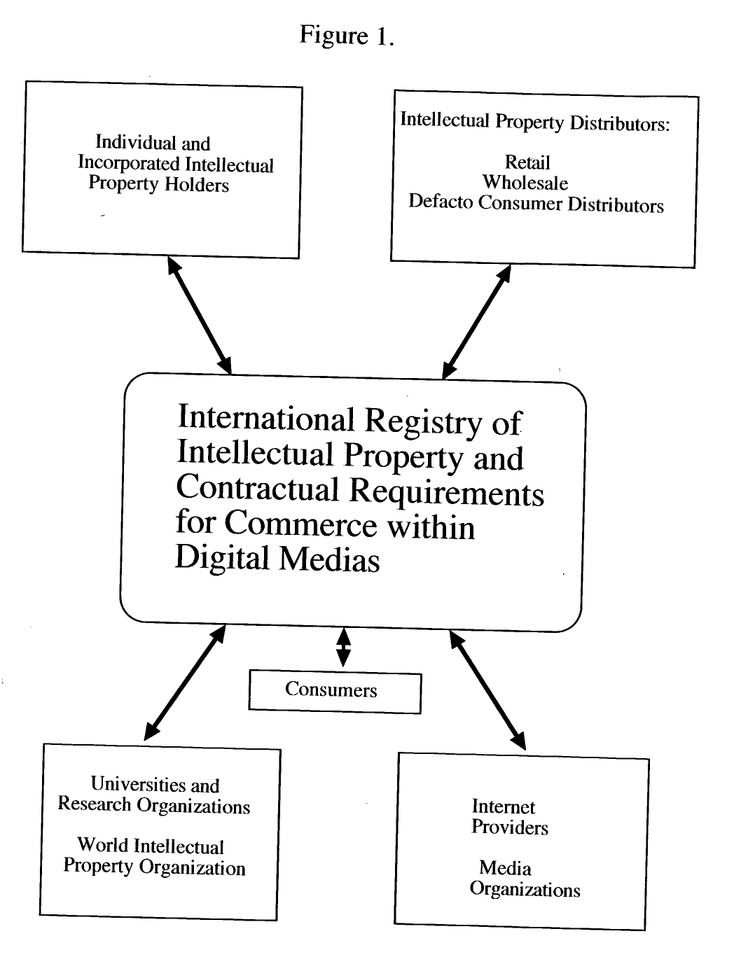

### DESCRIPTION OF THE PREFERRED EMBODIMENTS

The preferred embodiment of the present invention employs a secured, physically dispersed and redundant system of computers attached to a backbone of the Internet. This Sub Network of computers shall be established with stability, reliability and security as foremost considerations. Holders of Intellectual Property who decide to employ the present invention are requested to submit copies of their Intellectual Property, proof of identification, and further contractual information to be associated with said Intellectual Property as a requirement of commerce to a Governing Body, which regulates said Sub Network. The Sub Networks Governing Body checks the validity of submitted information. Upon verification of the accuracy of submitted materials the Governing Body will endorse the application of an Intellectual Property Identifier to be associated with the submitted Intellectual Property. The protocols of Intellectual Property Identifiers have not been established, and there is a possibility that a generic Intellectual Property Identifier, such as a generic Top Level Domain (ie. .org, .com) may be adopted for Internet applications. In association with this or other developments, a generic, and or unique Intellectual Property Identifier shall be endorsed and associated with an individual Intellectual Property by the Sub Networks Governing Body. Further information may be associated with said Intellectual Property in the interest of promoting commerce. Pending patent application Ser. No. 09/569,388 delineates further details of Intellectual Property Identifiers and associated information which may be employed independently or collectively with an associated Intellectual Property. As stated in said pending patent application Ser. No. 09/569,388 said Intellectual Property Identifier, and associated information may be encoded, watermarked upon or within or in some other fashion be made secure with a digitized Intellectual Property.

All associated above delineated information shall be archived upon said Sub Networks computers. There shall be firewalls, redundant checks and protection as would be understood by those versed in the art of Internet security, in place upon said Sub Network. Secure protocols will then be placed to enable said archived information to be referenced when in the interest of commerce.

It is herein suggested that said Sub Network may also act as a distributor of Intellectual Property when required in the interest of commerce.

It may be determined that the present invention be employed within the current Internet's existing framework. The present invention may physically reside as an aspect of the Internet's current “Root A”. If this is regarded as unacceptable for political or other reasons, a mirror type system or sub system may house the present inventions structure. It may prove that an independent, redundant Sub Network shall be established privately. As in the Domain Name System (DNS), the issues of security, reliability, and stability promote the need for a centralized or monopolistic “Root”.

In seeking patent protection for the establishment of an authoritative archive and reference for Intellectual Properties which shall serve to promote commerce and act to verify the validity of contractual agreements within digital medias, the present applicant respectfully submits that further novel aspects of the present invention exist. It is herein suggested that the present invention shall establish an International depository and disseminator of Intellectual Property and commerce requirements there of world wide; a unique and valuable institution with novel methods of doing business.

As precedented by the development of the Internet itself and further by the development of the DNS, the issues of security, reliability, and stability promote the need for a centralized or monopolistic “Root” at the onset. It is therefore respectfully suggested herein that a properly chartered and managed institution as delineated in the present invention shall prove itself beneficial to the economic and sociopolitical development of humanity on a global level. In light of the aforementioned arguments, the author respectfully requests patent protection for the present invention.

Many variations of the processes described in the present application are possible without straying from the spirit and benefits which may be associated with the present invention. The present invention may also give rise to techniques and protocols not delineated herein, which shall also be embraced within the scope of the present invention.

What I claim is:

1. A registrar for Intellectual Property, including contractual requirements for commerce within digital mediums, and further information associated with Intellectual Properties for the purpose of promoting intellectual advancement, and commerce within and without digital media.

2. A registrar in accordance with claim 1 wherein:
said registrar includes the registration of generic and Property Specific Intellectual Property Identifiers.

3. A registrar in accordance with claim 2 and further including:
the association of said Intellectual Property with a lower level protocol insignia and or watermarking, embedding or other methods known in the art which serve to secure Intellectual Property Identifiers and further information in the interest of commerce, with said Intellectual Property.

4. A referential resource, accessible worldwide via digital means, of International Intellectual Property, requirements of commerce for the sale, proliferation and transfer of said Intellectual Property, and the ability to disseminate said information as a distributor of Intellectual Property in the interest of commerce, or the advancement of global intellectual development.

5. A referential resource in accordance with claim 4. wherein:
said referential resource includes the registration of generic and Property Specific Intellectual Property Identifiers.

6. A registrar in accordance with claim 5 and further including:
the association of said Intellectual Property with a lower level protocol insignia and or watermarking, embedding or other methods known in the art which serve to secure Intellectual Property Identifiers and further information in the interest of commerce, with said Intellectual Property.

7. Establishing in the interest of commerce:
a digital referential Network Sub system of computers, established as an independent “Root”, held secure, stable, and accessible via the world wide web, for the purpose of registering and referencing International Intellectual Property, and associated information thereof including, contractual considerations for commerce and individual digital Intellectual Property Identifiers.

8. An authoritative archive and reference for Intellectual Properties which shall serve to promote commerce and act to verify the validity of contractual agreements within digital media's. Said digital reference library housing Intellectual Property Identifiers which establish Intellectual Properties as unique and bound to restriction with regard to sale transfer and proliferation within digital media's. Said digital reference further containing information associated with individual Intellectual Properties in the interest of effecting commerce within digital media's. Said digital reference archive further serving to validate the requirements of contractual agreements employed in commerce within and without of digital domains.

9. An authoritative archive and reference for Intellectual Properties in accordance with claim 8. wherein:
the embodiment of the authoritative archive and reference for Intellectual Properties is housed in a physically dispersed and redundant system of computers addressable via the Internet, said archive being made secure and residing as a sub network of the Internet.
